(19) United States
(12) Patent Application Publication
(10) Pub. No.: US 2006/0164389 A1
(43) Pub. Date: Jul. 27, 2006

(54) Method of controlling a multimedia device for a motor vehicle and a device implementing said method

(75) Inventor: Nicolas Ringot, Mittainville (FR)

Correspondence Address: YOUNG & THOMPSON, 745 SOUTH 23RD STREET, 2ND FLOOR, ARLINGTON, VA, 22202, US

(73) Assignee: Siemens VDO Automotive, Toulouse Cedex 1 (FR)

(21) Appl. No.: 10/527,165

(22) PCT Filed: Aug. 28, 2003
(86) PCT No.: PCT/EP03/09505

§ 371 Date: Mar. 9, 2005

(30) Foreign Application Priority Data
Sep. 11, 2002 (FR) 0211217

(51) Int. Cl. G09G 5/08

(52) U.S. Cl. 345/157

(57) ABSTRACT

The invention relates to a method of controlling a multimedia device, which employs a graphic display screen (130) and a biaxial button (150) (up/down right/left). According to the invention, if the biaxial button is pressed in a first axis, a function can be selected from a looped scrolling menu (131) which is displayed on the graphic display screen and, if the biaxial button is pressed in the second axis, a parameter of the selected function can be adjusted. Preferably, the selected function is permanently displayed at the centre of the scrolling menu (131) and takes the form of a laterally-viewed cylinder or drum with a horizontal axis. The parameter adjustment range appears in the form of an adjustment bar (140) which extends perpendicularly to the scrolling menu (131) and which forms part of the permanent function display.

The subject of the present invention is a method of controlling a multimedia apparatus for automobiles and such an apparatus using this method. It applies in particular to automobile radios and/or navigation systems.

The general problem which the present invention attempts to address is how to supply a means of controlling/selecting the various functions of the apparatus that is as intuitive as possible and how to minimize the distraction to the driver when operating it in order to avoid any negative impact on driving safety.

The documents WO 99/22447 and EP 0347 686 are known. These two documents-propose the use of a rotary button the rotation of which in one direction or the other supplies the apparatus with pulses (where appropriate together with an indication of the direction of rotation) serving to select a function or adjust a parameter of that function, the switching between the function selection mode and the adjustment mode being performed by actuation in a third direction, for example by pushing on the button (example: selection of volume from the volume, balance, bass, treble, etc functions, and then adjustment of the sound intensity after pressing the button in—momentarily or otherwise). This device has the disadvantage of absorbing the attention of the driver when determining which mode (selection/adjustment) the device is in.

The present invention intends to remedy these disadvantages. Specifically, the subject of the present invention is a method of control, of the type using a graphic screen and a bi-axial button (up/down-right/left) characterized in that the actuation of the bi-axial button in a first axis selects a function in a scrolling menu displayed on said graphic screen and in a continuous loop, and the actuation of the bi-axial button in the second axis is for adjusting a parameter of the selected function.

Due to these dispositions, the user chooses, on the first axis, the function he wants to select and then, on the second axis, adjusts a parameter of that function. The adjustment is therefore quick and requires only very little attention from the user.

According to particular features, the selected function appears permanently in the center of the scrolling menu. Due to these dispositions, the selected function is easily identifiable and is flanked by the closest functions in the scrolling menu.

According to particular features, the scrolling menu is in the form of a cylinder or drum with horizontal axis when viewed laterally. Due to these dispositions, the direction of rotation of the drum may correspond to an axis of the bi-axial button.

The subject of the present invention is also a multimedia apparatus using the method as concisely set forth above, in which the bi-axial button is situated on the apparatus or remote from it.

Other advantages, aims and features of the present invention will emerge from the description that follows, offered in conjunction with the appended drawing wherein:

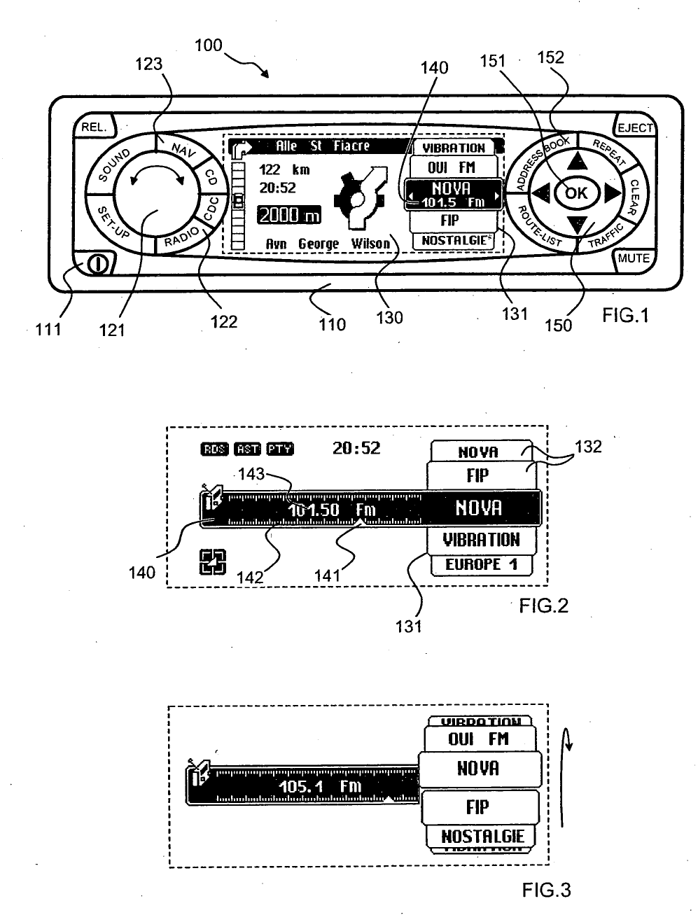

FIG. 1 represents a front face of a device implementing a particular embodiment of the present invention;

FIGS. 2 to 6 represent images displayed on a screen illustrated in FIG. 1, in accordance with various operating modes of the device illustrated in FIG. 1.

FIG. 1 shows a front face 110 of a multimedia apparatus 100, in this instance an automobile radio incorporating navigational aid functions, comprising a screen 130, a bi-axial button 150, four corner buttons including for example an on-off button 111, an OK button 151 in the center of the bi-axial button 150, five buttons 152, peripheral to the bi-axial button 150, a rotary button 121 for adjusting the sound volume and six mode selection buttons (for example for selecting the “RADIO” mode 122 or “NAVIGATION” mode 123) situated around the rotary button 121.

The front face 110 of the multimedia apparatus is electrically connected to electronic circuits (not shown) which supply navigation, automobile radio, telephone, or compact disc or audio cassette drive functions, for example. The front face 110 has the standard front face dimensions of an automobile radio.

The four corner buttons each correspond to a specific function which has no variable. For example, the corner button 110 corresponds to the “on-off” control of the apparatus, the “EJECT” corner button to the compact disc ejection function, the “MUTE” corner button for silencing any sound transmission made by the multimedia apparatus, and the “REL.” (abbreviation for “release”) corner button is for opening the front of the set.

The six mode selection buttons correspond respectively to the following operating modes of the multimedia apparatus 100:
“NAV” (button 123) is for selecting the navigation aid mode,
“CD” is for selecting the mode for playing a compact disc inserted into a slot of the multimedia apparatus 100,
“CDC” is for selecting the mode for playing a compact disc stored in a changer containing a plurality of compact discs,
“RADIO” (button 122) is for selecting the mode for listening to a radio,
“SET-UP” is for selecting parameters of general use of the multimedia apparatus 100, and
“SOUND” is for access to a sound adjustment menu: tone, balance, etc.

According to the embodiments, the bi-axial button 150 of the multimedia apparatus 100 may be situated on the apparatus itself or remote from it. The bi-axial button 150 has two axes each provided with two buttons placed in opposite directions. One of the axes is vertical and the other horizontal. The button 151 in the center of the bi-axial button 150 is for confirming certain choices made by the user by means of the bi-axial button 150, as explained below.

The five buttons 152, peripheral to the bi-axial button 150, correspond respectively to the following functions of the navigation system incorporated into the multimedia apparatus 100:
“ADDRESS-BOOK”, providing access to a book of geographic addresses used for navigation,
“REPEAT”, providing access to a repeat of the last voice message transmitted by the navigation aid system,
“CLEAR”, for clearing the destination selection or the place of origin selection,
“TRAFFIC”, for displaying road traffic information and
“ROUTE-LIST”, for choosing a route.

The screen 130 is a graphic screen, a liquid crystal display for example. It is suitable for displaying the images illustrated in FIGS. 1 to 6, either in monochrome or in color. In each of these figures can be seen:
a scrolling menu 131 in a continuous loop, that is to say during prolonged vertical scrolling (controlled by the actuation of the bi-axial button 150 along the vertical axis), the functions reappear cyclically at one end of the scrolling menu 131, scroll past and disappear at the other end of the scrolling menu.
an adjustment bar 140 extending perpendicular to the scrolling menu 131 and integral with the function indication and used for adjusting a parameter of the function selected from the scrolling menu.

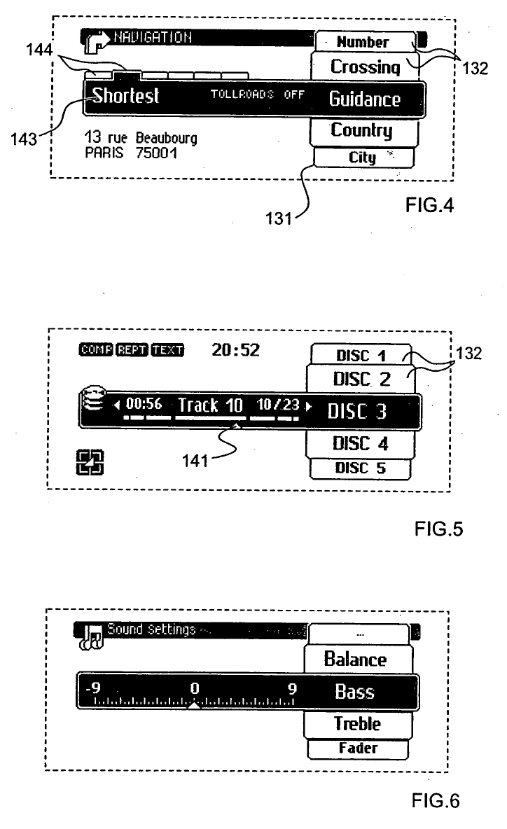

In the embodiments illustrated in FIGS. 1 to 6, the scrolling menu 131 is in the form of a cylinder or a drum with horizontal axis when viewed laterally, and its visible surface is divided into facets 132 each carrying the indication of a function depending on the chosen operating mode. For example, in FIGS. 1 to 3, in which the operating mode is listening to the radio, the scrolling menu is for selecting a radio station (function) and each facet carries the name of a pre-set radio station. In FIG. 4, in which the operating mode is navigation, the scrolling menu is for selecting a function such as guidance, the input of destination data, etc and each facet carries an indication of that function. Likewise, in FIG. 5, in the mode for listening to compact discs, each facet represents one of the discs in the changer, or in FIG. 6, in sound adjustment mode, each facet corresponds to one of the functions: bass, treble, balance, etc.

The selected function remains in the center of the apparent portion of the menu, when it scrolls, for example in the third interval when five intervals are shown. In addition, the selected function is preferentially displayed in reverse video, that is to say in white on a black background. Also, by applying a perspective effect, as if the functions were written on a cylinder or a drum with horizontal axis when viewed laterally, the unselected functions which flank the selected function are given a lesser visual importance than that of the selected function while they nevertheless remain displayed so that the user can easily identify the successive functions that he might select.

The scrolling menu 131 is controlled by the user actuating the bi-axial button 150, preferentially by actuation in its vertical axis. When the user presses on the down key of the bi-axial button 150, he causes the scrolling menu/functions cylinder to rotate upward, which has the effect of centralizing and selecting the function that previously appeared beneath the central selected function. Conversely, when the user presses on the up key of the bi-axial button 150, he causes the scrolling menu/functions cylinder to rotate downward, which has the effect of centralizing and selecting the function that previously appeared above the central selected function. This selection process may be embellished with a visual animation giving the impression of a rotation of the drum, as shown in FIG. 3. In this case, while the drum is rotating, all the facets are rendered in normal video until a new function is selected. Then the corresponding facet 132 will again be displayed in reverse video.

When a function is selected, an adjustment bar 140 for adjusting a parameter of the function chosen on the scrolling menu extends laterally on the screen 130, perpendicular to the axis of scrolling of the menu, to display the parameter values that may be selected by using the right and left keys of the bi-axial button 150.

According to the operating modes, the appearance of the scrolling menu/functions cylinder 131 and of the adjustment bar 140 changes. Thus, when there is only one operating mode to be displayed on the screen, for example because the navigation aid system is not in service or it does not require the immediate attention of the driver, as shown in FIGS. 2 to 6, the description of the function and of its primary parameter is more extended on the screen 130 than when two operating modes are displayed simultaneously on the same screen, as illustrated in FIG. 1. When the user is using two operating modes simultaneously (for example an audio application and a navigation application), the parameter value of the function chosen in the scrolling menu 131 is displayed in said scrolling menu, for example just below the textual description or the icon of the selected function. The adjustment bar 140 is then under the indication of the function in simplified form. The rest of the screen 130 is used for displaying the navigation aid function.

When a single operating mode is displayed, the adjustment bar 140 extends across the whole width of the screen, in the extension of the facet corresponding to the selected function and integral with the latter. It is therefore represented in reverse video. The parameter is adjusted by means of an actuation of the bi-axial button 150, along the axis perpendicular to the axis for scrolling the scrolling menu, that is to say preferably the horizontal axis. According to the selected function, the adjustment may be continuous, by pressing and holding down the right or left keys of the bi-axial button 150, as in the example of adjusting a frequency of a radio station, illustrated in FIG. 2. In this case, the adjustment is materialized by the movement of a cursor 141 on a graduated scale 142 in the direction corresponding to the key actuated. An alphanumeric display 143, situated in the center of the adjustment bar 140, is for the precise adjustment, and the display of additional information such as the frequency range used. The adjustment may also be made in discrete manner, as illustrated in FIG. 4, by successive brief presses on the keys of the horizontal axis of the bi-axial button 150 to select a tab 144 representing a predetermined option from a list of possible choices for the function in question, the identification of the option being able to be displayed on the alphanumeric display 143. A combination of the discrete and continuous adjustment modes may also be used, as in the example of playing a compact disc illustrated in FIG. 5, in which brief presses are used to select the track of the disc to be played, identified on the alphanumeric display 143, in the center of the adjustment bar 140 and long presses are used to skip the reading beam forward or backward quickly within the selected track, the position of the beam being materialized by that of the cursor 141.

According to variants, the selected parameter value (including when a sub-function is involved) remains in the middle of the adjustment bar 140 or of the interval of parameter values that is represented. The new parameter value usually takes effect automatically. However, in certain cases, in particular for choices made for navigational aid, the central button 111 (“OK” for confirmation) of the bi-axial button 150 is pressed to confirm a choice of a parameter value.

Although the figures are by nature static, it can be seen that, in accordance with variants of the embodiments of the present invention, each graphic element displayed on the graphic screen 118, and, in particular, the adjustment bar, may present an animation.

Thus the multimedia apparatus 100 that is the subject of the present invention displays the two primary control levels in a structure with two axes corresponding to the two axes of the bi-axial button 150, thus generating a logical and tight relationship between the information displayed and the two control axes materialized by the two axes of the bi-axial button 150. In this manner, the user sees, on the screen 130, two levels of control which he controls directly by means of the bi-axial button 150. He may select a function, by pressing one of the buttons corresponding to the vertical axis of the bi-axial button 150 until the desired function appears in the middle of the scrolling menu, and set a new parameter value of the selected function by pressing one of the buttons corresponding to the horizontal axis of the bi-axial button 150.

In the embodiment represented, all the audio functions are controlled by means of the two axes of the scrolling menu 131 and of the bi-axial button 150 and the user uses only this type of interface which is easy to understand and to master and requires less attention during the driving phases.

The present invention thus gives the user direct and explicit access to the various levels of control required by the multimedia applications evoked here.

1. A method of controlling a multimedia apparatus, of the type using a graphic screen and a bi-axial button (up/down-right/left) characterized in that actuation of the bi-axial button in a first axis selects a function in a scrolling menu displayed on said graphic screen and in a continuous loop, and actuation of the bi-axial button in the second axis is for adjusting a parameter of the selected function.

2. The method as claimed in claim 1, characterized in that the selected function appears permanently in the center of the scrolling menu.

3. The method as claimed in claim 1, characterized in that the scrolling menu is in the form of a cylinder or drum with horizontal axis when viewed laterally.

4. The method as claimed in claim 1, characterized in that, when the function has been selected, the range of adjustment of the parameter appears in the form of an adjustment bar extending perpendicular to the scrolling menu and being integral with the indication of the function.

5. The method as claimed in claim 4, characterized in that, for at least one function, the adjustment bar is in the form of a cursor on a graduated scale.

6. The method as claimed in claim 4, characterized in that, for at least one function, the adjustment bar is in the form of a series of tabs.

7. The method as claimed in claim 1, characterized in that, if the rest of the screen is occupied by the display of a second function, the adjustment bar is positioned in simplified form under the function indication.

8. The method as claimed in claim 1, characterized in that, in said scrolling menu, the unselected functions have a lesser visual importance than the selected function but remain displayed.

9. The method as claimed in claim 1, characterized in that, in said scrolling menu, the selected function appears in reverse video relative to the other functions.

10. A multimedia apparatus using the method as claimed in claim 1, characterized in that the bi-axial button is situated on the apparatus or remote from it.

11. The method as claimed in claim 2, characterized in that the scrolling menu is in the form of a cylinder or drum with horizontal axis when viewed laterally.
